(19) United States
(12) Patent Application Publication
(10) Pub. No.: US 2016/0092968 A1
(43) Pub. Date: Mar. 31, 2016

(54) NON-VISUAL ENCODED COMMERCIAL REQUEST GENERATION

(71) Applicant: Harald Fees, Mainzweiler (DE)

(72) Inventor: Harald Fees, Mainzweiler (DE)

(21) Appl. No.: 14/496,945

(22) Filed: Sep. 25, 2014

(51) Int. Cl. G06Q 30/06

(52) U.S. Cl. CPC G06Q 30/0635; G06Q 30/0609

(57) ABSTRACT

A method, device, and system for generating and accessing consumer commercial requests. A commercial request is generated by a consumer using a non-visual encoded commercial request device. Each consumer has a unique consumer identification barcode that is scanned, authenticated, and collected by the device. Following successful consumer authentication, target barcodes are scanned that represent various goods or services. The target barcodes are collected by the device. Upon completion of the scanning, the device generates a commercial request that is sent to a server. Vendors can request access to their respective commercial requests, and the server sends associated orders to the vendors. A speaker is connected as output to the non-visual encoded commercial request device, and the speaker provides feedback on the commercial request progress to the consumer.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyrights whatsoever.

### FIELD

A method, device, and system that relate to generation of consumer commercial requests for goods or services by a non-visual encoded commercial request device that includes a barcode scanning device as an input device and a speaker as an output device; and, in addition the invention relates to a server handling the generated consumer commercial requests and the server handling vendor requests to access the generated commercial requests.

### BACKGROUND

Shopping for goods, especially routine household or business goods, can be burdensome and require a significant investment of time from a consumer. Similarly, scheduling an appointment can require a significant time investment due to a consumer's time limitations and the limited operating business hours of a vendor. A growing portion of the product and service consumption community is composed of elderly persons, persons who dislike shopping, and persons with significant time restraints. Shopping and appointment management can be burdensome on these community members as it requires a sizable investment of time. Additionally, these community members and similar members of the product and service consumption community do not always have access or consistent access to either the internet or physical retail stores. However, such members of the consumption community still require that their goods and services needs be met.

Enterprise computing, which includes enterprise resource planning (ERP), integrates organizational systems to facilitate transactions involving goods or services. Some ERP systems have provided support for processes in sales and distribution for users. These ERP systems are introduced to users and vendors through network connections and require all parties to have access to a device with a monitor (such as a personal computer or a mobile device) and a network connection. Typically, the ERP systems have monitors or displays and require consumers to log-in to (and/or register) a consumer associated user account. A log-in or registration process is generally necessary on these display devices because more than one party can have easy access to the device. After having logged in, the consumer then identifies goods or services that he desires to purchase by browsing the vendor's offerings, or, if available, searching the vendor's offerings, both of which require the consumer to commit to an additional investment of time. ERP systems can also require a consumer to spend an inordinate amount of time waiting for a vendor to confirm an appointment or the availability of a resource.

Accordingly, there is a need for streamlining retail sales and/or appointment management, especially for those parties with insufficient time and/or interest in shopping.

### BRIEF DESCRIPTION OF THE DRAWINGS

FIG. 1 is a block diagram of a non-visual encoded commercial request system 100 according to an example embodiment.

FIG. 2 illustrates a non-visual encoded commercial request device 200 in a consumer-end environment according to an example embodiment.

FIG. 3 illustrates a vendor interface 300 for viewing data retrieved from the non-visual encoded commercial request system according to an example embodiment.

FIG. 4 illustrates a diagram of data records 400 stored in the database of a server and database environment portion of the non-visual encoded commercial request system according to an example embodiment.

FIG. 5 is a barcode booklet 500 that is used in conjunction with a non-visual encoded commercial request device according to an example embodiment.

FIG. 6 illustrates an unique consumer identification barcode 600 that is used in conjunction with a non-visual encoded commercial request device according to an example embodiment.

FIG. 7 is a flowchart of a method 700 for generating a commercial request using a non-visual encoded commercial request device according to an example embodiment.

FIG. 8 is a flowchart of a method 800 for generating a commercial request using a non-visual encoded commercial request device according to an example embodiment.

FIG. 9 is a flowchart of a method 900 for accessing and altering a processed commercial request by a vendor according to an example embodiment.

### DETAILED DESCRIPTION

Example embodiments of the present invention provide for a method, device, and system for generating and accessing consumer commercial requests. A commercial request is generated by using a non-visual encoded commercial request device. A generated commercial request is received by a server, and the commercial request is stored and later accessed by a vendor according to an example embodiment.

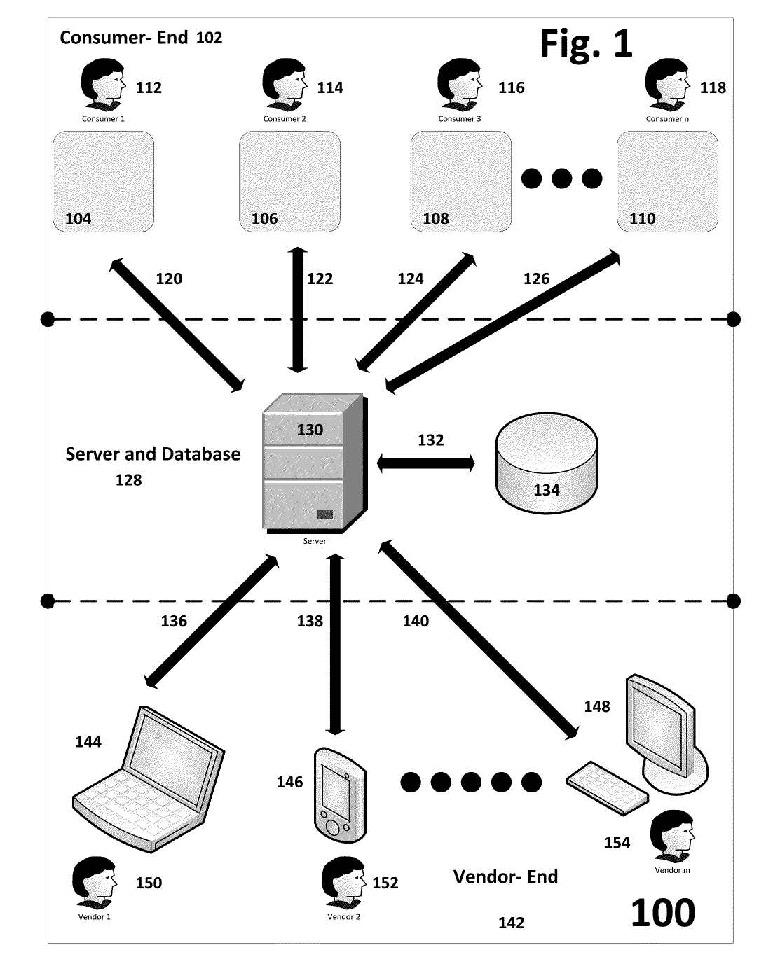

FIG. 1 is a block diagram of a non-visual encoded commercial request system 100 according to an example embodiment. FIG. 1 illustrates three tiers of activity in the system 100, including a consumer end environment 102, a server and database environment 128, and a vendor end environment 142. The system 100 handles commercial requests generated by n consumers (including all consumers from consumer 112 to consumer 118) at the consumer end environment 102. Each of the n consumers in the system initiates at least one commercial request. In the server and database environment 128, the server 130 receives communication requests initiated by the n consumers and stores the communication requests in associated database 134. Upon receipt of a commercial request, the server 130 evaluates and processes the commercial request, and then the server 130 saves the evaluated and processed commercial request by sending it to a database 134 for storage. Server 130 is connected to database 134 by a bidirectional communication line 132. Database 134 provides a location for storage of the evaluated and processed communication requests from n consumers and the communication requests are stored in database 134 until retrieved by the server 130 to be sent to a respective vendor. In an embodiment, bidirectional communication line 132 is wireless. In the vendor end environment 142, m number of vendors (including all vendors from vendor 150 to vendor 154) view stored communication requests sent from server 130 through a respective computing device. The m number of vendors can each use one of various types of computing devices such as laptop 144, mobile device 146, and computer terminal 148.

In an embodiment of the system, commercial requests from the n consumers are handled by the m vendors where n:m is not a one to one relationship. In an embodiment of the invention, at least one of the commercial requests from the n consumers is handled by at least two of the m vendors. In an embodiment at least one of the commercial requests from the n consumers is handled by only one of the m vendors. Upon fulfillment of a commercial request by a vendor, the vendor can request that the server 130 store or update fulfillment data associated with the processed commercial request. In an embodiment, that is introduced in addition to the previous embodiment, upon successful receipt of a stored commercial request from the server and database environment 128 of the commercial request by a vendor, the vendor requests that the server 130 store a notification from the vendor to be associated with the stored commercial request.

In FIG. 1, the three tiers of activity are connected via communication lines. Consumer end environment 102 is connected to the server and database environment 128 via communication lines 120, 122, 124, and 126. Each of these consumer end communication lines 120, 122, 124, and 126 carries a communication request that was generated by a consumer at one of the consumer devices, which include devices 104, 106, 108, and 110, respectively, to the server 130 in the server and database environment 128. In an embodiment, consumer 112 can use any one of the consumer end devices such as 104, 106, 108, and 110. Accordingly, any one of consumers 112, 114, 116, and 118 can use or share any of consumer end devices 104, 106, 108, and 110. In particular, device sharing is advantageous among consumers in an office or in a family setting. In an embodiment, a consumer end device is placed in a public setting, for use by the general public. In an embodiment of the system, at least one of the communication lines 120, 122, 124, and 126 is formed over a wireless network. Server and database environment 128 is connected to the vendor end environment 142 via communication lines 136, 138, and 140. Each of these vendor end communication lines 136, 138, and 140 carries a request from a vendor for the stored communication requests that were generated by a vendor at one of the vendor end devices, which include devices 144, 146, and 148, respectively, to the server 130 in the server and database environment 128. In an embodiment of the system 100, at least one of the communication lines 136, 138, and 140 is formed over a wireless network.

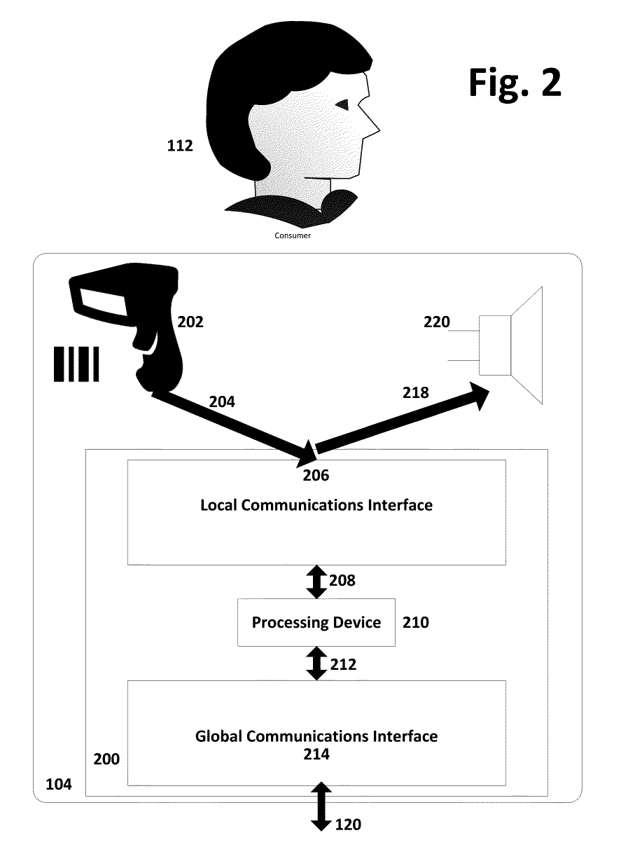

FIG. 2 illustrates a non-visual encoded commercial request device 200 in a consumer end environment according to an example embodiment. Consumer end environment, for each of the n consumers, has a consumer device 104. Consumer device 104 includes a barcode scanning device 202, a speaker 220, and a non-visual encoded commercial request device. In the consumer device 104, barcode scanning device 202 is used by the consumer 112 to provide input to the non-visual encoded commercial request device 200. Speaker 220 provides the consumer 112 audio output related notifications from non-visual encoded commercial request device 200. The non-visual encoded commercial request device 200 further includes at least the following: a local communications interface 206, a processing device 210, a global communications interface 214, and internal bidirectional communication lines 208 and 212. Communication line 208 is formed between local communications interface 206 and processing device 210. Communication line 212 is formed between processing device 210 and global communications interface 214. In an embodiment, a database or a local memory is included in the non-visual encoded commercial request device 200. In an embodiment, a single communications interface is implemented with the capability to transmit and receive data both locally to the input and output devices of non-visual encoded commercial request device 200 and globally to the server database environment in the system. In an embodiment, local communications interface 206 and global communications interface 214 each include at least a transceiver for transmitting information related to a commercial request and a receiver for receiving information related to a commercial request. In an embodiment, at least one of communication line 204, communication line 218, and communication line 120 is formed over a wireless network.

A consumer, such as consumer 112, generates a commercial request with consumer input device 104 by scanning barcodes using barcode scanner 202. Scanned barcodes are transmitted as input via communication line 204 to the non-visual encoded commercial request device 200. A receiver of local communications interface 206 receives the commercial request and forwards it via communication line 208 to processing device 210. In an embodiment, processing device 210 authenticates information associated with the commercial request. If the authentication is successful, processing device 210 sends the communication request via communication line 212 to global communications interface 214. Global communications interface 214 transmits the communication request over communication line 120 to the server and database environment 128. If authentication is unsuccessful, processing device sends a notification via communication line 208 to the local communications interface 206, which transmits the notification over communication line 218 to be announced by speaker 220 to the consumer 112.

In an embodiment, after a successful transmission of a commercial request over communication line 120, a confirmation of receipt of the commercial request is returned from the server and database environment 128 also over communication line 120. The confirmation of receipt is received by global communications interface 214 and forwarded via communication line 212 to the processing device 210. Processing device 210 sends the confirmation via communication line 208 to the local communications interface 206, which transmits the confirmation via communication line 218 to be announced by speaker 220 to the consumer 112.

The processing device 210 located in the non-visual encoded commercial request device is in an embodiment a processor hosted on a single board computer. In an embodiment, the single board computer hosting the processor is a Raspberry Pi. Processing device 210 can be one of a microprocessor, a multi-core processor, or a central processing unit. Processing device 210 hosts an operating system that executes software to perform all described processing tasks needed in the non-visual encoded commercial request device. In an embodiment, software that is executed on the processing device is written in JAVA.

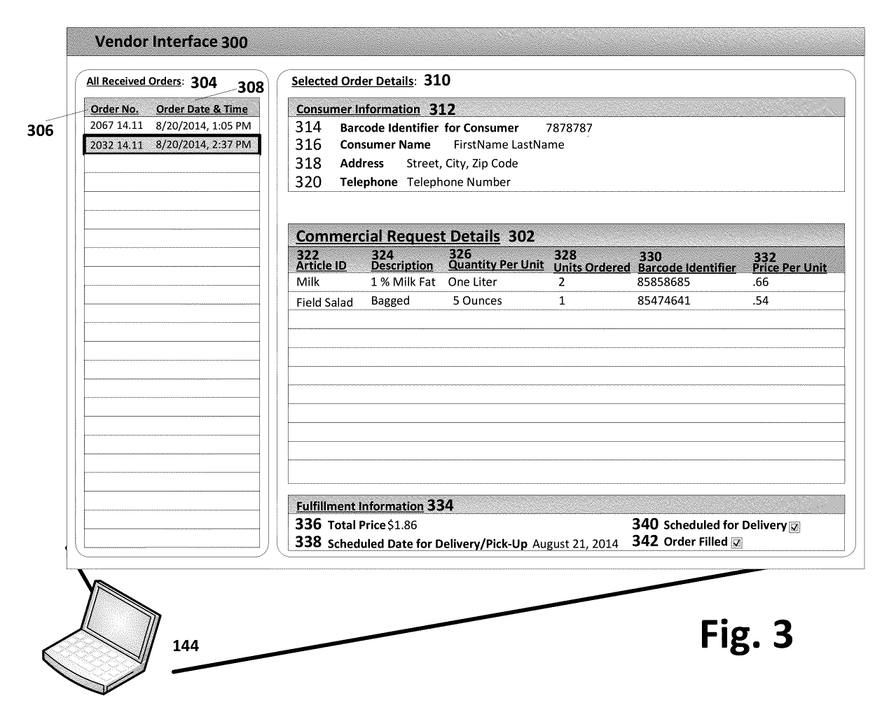

FIG. 3 illustrates a vendor interface 300 for viewing data retrieved by a vendor from the non-visual encoded commercial request system according to an example embodiment. FIG. 3 illustrates a vendor interface 300 of vendor end device 144. Vendor interface 300 provides a vendor with information having to do with the consumer's generated commercial request. A listing of all received orders 304 placed with the viewing vendor is displayed in vendor interface 300. For a selected order listed in 304, details of the commercial request 302 are displayed for the vendor. In an embodiment, the vendor can review an order number 306 and an order date and time 308 for each of the received orders listed in all received orders 304. In an embodiment, the vendor selects one of the received orders from the list supplied in all received orders 304, such as Order Number 2032 14.11.

A vendor viewing vendor interface 300 can select a particular order to view its selected order details 310. In an embodiment, selected order details 310 include consumer information 312, commercial request details 302, and fulfillment information 334. Consumer information 312 includes a barcode identifier for the consumer 314, the consumer name 316, the consumer address 318, and the consumer telephone number 320. Commercial request information 302 includes an Article ID 322, a description of the article 324, a quantity per unit of the article 326, the number of units ordered by the consumer 328, the barcode identifier of the article 330, and the vendor's listed price per unit 332 for the ordered article. Fulfillment information 334 includes a total price 336 of the commercial request, a scheduled date for delivery or pick-up 338 of the commercial request, an indicator as to whether the commercial request is for delivery 340, and an indicator as to whether the commercial request has been filled by the vendor 342.

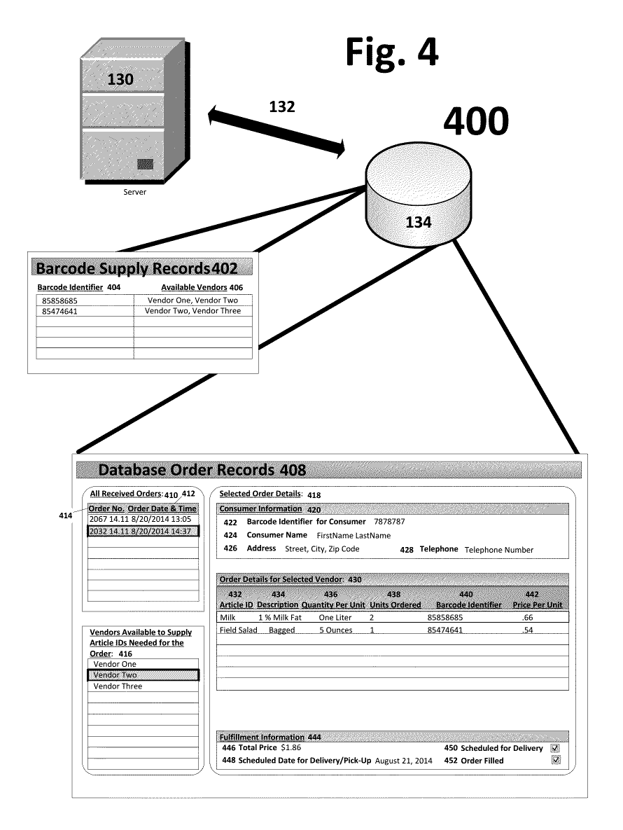

FIG. 4 illustrates a diagram of data records 400 stored in the database 134 of a server and database environment portion of the non-visual encoded commercial request system according to an example embodiment. FIG. 4 illustrates detail regarding the server and database environment 128. Server 130, which includes a processing device, communicates over communication line 132 with database 134. Server 130 stores in database 134 commercial requests in database order records 408. Upon request from a vendor, server 130 retrieves from database 134 database order records 408 associated with the vendor and transmits the records to vendors. In an embodiment, server 130 transmits information to database 134 in order to update database order records 408 based on vendor activity.

In an embodiment, the processing device of server 130 is one of a microprocessor, a multi-core processor, or a central processing unit. The processing device has an operating system that executes software to perform all described processing tasks needed to support commercial requests or vendor requests to see data related to the non-visual encoded commercial request device. In an embodiment, the software that is executed on the processing device is JAVA.

Database 134 is shown in FIG. 4 to include at least Barcode Supply Records 402 and Database Order Records 408. Barcode Supply Records 402 include information about product availability at various vendors. Barcode Supply Records 402 includes at least a Barcode Identifier Field 404 and an Available Vendor Field 406. Barcode Supply Records indicate whether a specific product is available with all available vendors or a subset of all vendors. In an embodiment, Barcode Supply Records 402 also indicates that a product is not available from any of the available vendors. Database Order Records 408 includes a log of all orders 410 received by the server 130. Upon receiving a commercial request, the processor of server 130 associates the commercial request with an order number 414 and an order date and time 412. Order number 414 and order date and time 412 are stored in the database 134. For each commercial request, information is stored regarding consumer information 420, commercial request details 430, vendors available to supply the article IDs needed for the order 416, and fulfillment of the order 444. Consumer information 420 includes a barcode identifier for the consumer 422, the consumer name 424, the consumer address 426, and the consumer telephone number 428. Commercial request information 430 includes an Article ID 432, a description of the article 434, a quantity per unit of the article 436, the number of units ordered by the consumer 438, the barcode identifier of the article 440, and the price per unit of the article 442 for the selected vendor. Fulfillment information 444 includes a total price 446 of the commercial request, a scheduled date for delivery or pick-up 448 of the commercial request according to the selected vendor, an indicator as to whether the commercial request is for delivery 450, and an indicator as to whether the commercial request has been filled by the vendor 452. In an embodiment, Barcode Supply Records 402 catalogs barcodes with their associated goods or services according to the item or service. In an embodiment, the Barcode Supply Records 402 catalogs barcodes in accordance with their respective International Article Number (EAN).

In an embodiment, database 134 stores additional authentication information to check a unique consumer identification barcode. Database 134 includes additional authentication data used to check that the unique consumer identification barcode is a valid identification and that it is being used by the assigned consumer. In an embodiment, database 134 stores data used as a predetermined number to encode a unique consumer identification number. In an embodiment, database 134 stores data used to decode a unique consumer identification barcode. In an embodiment, database 134 includes consumer information and consumer preferences to be used to assist in forming an order with at least one vendor.

In an embodiment, server 130 optimizes information related to the commercial request according to a fulfillment factor. The server 130 is preprogrammed to optimize according to a specific fulfillment factor. In an embodiment, the consumer selects the fulfillment factor for optimization. Server 130 compares fulfillment information available from different vendors for a commercial request. In an embodiment, server 130 compares the total price 446 for different vendors listed in 416. After having compared the total prices, the server selects the vendor associated with the lowest total price to fill the commercial request. In an embodiment, the server compares alternative fulfillment information such as a delivery date. If delivery date is compared, the server selects the vendor associated with the fastest delivery date to fill the commercial request. The server 130 can optimize the commercial request by assigning at least one vendor from the vendors available 416 to fill the order. Optimization of the commercial request is performed on at least any one of varying credentials used to describe an order/appointment by a consumer known to those in the art.

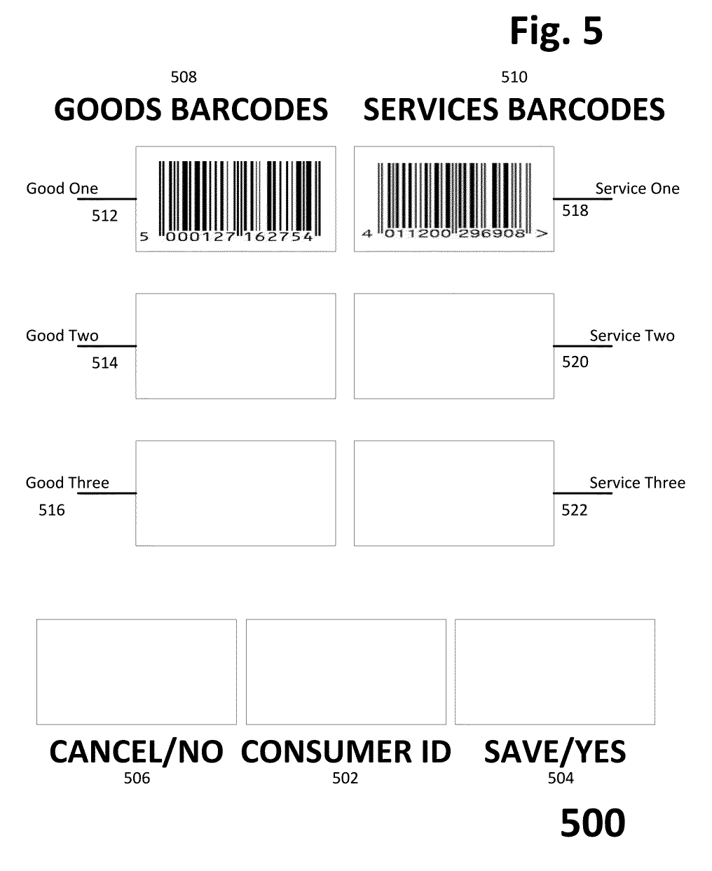

FIG. 5 is a barcode booklet 500 that is used in conjunction with a non-visual encoded commercial request device 200 according to an example embodiment. A consumer having a consumer device 104 can place a commercial request using at least a unique consumer identification barcode 502, a Save/Yes barcode 504, a Cancel/No barcode 506, and at least one order barcode such as barcode 512. In an embodiment, an order barcode is either one of a goods barcode 508 or a services barcode 510. In an embodiment, a consumer has a plurality of goods barcodes and a plurality of services barcodes at his disposal. In an embodiment, each order barcode is associated with a different good or service. For example, the barcode 512 is associated with Good One. Good One can be a good for sale, such as a banana, a liter of low-fat milk, or a broom. Barcode 518 is associated with Service One. Service One can be an appointment or a meeting, such as a dental appointment at 3 pm on an upcoming date with a particular local dentist. In an embodiment, the consumer has a booklet 500 of at least one order barcode. Barcodes can also be presented for scanning in a format different than a physical booklet, such as in an electronic format. In an embodiment, the booklet 500 is available on a mobile or handheld device in electronic form.

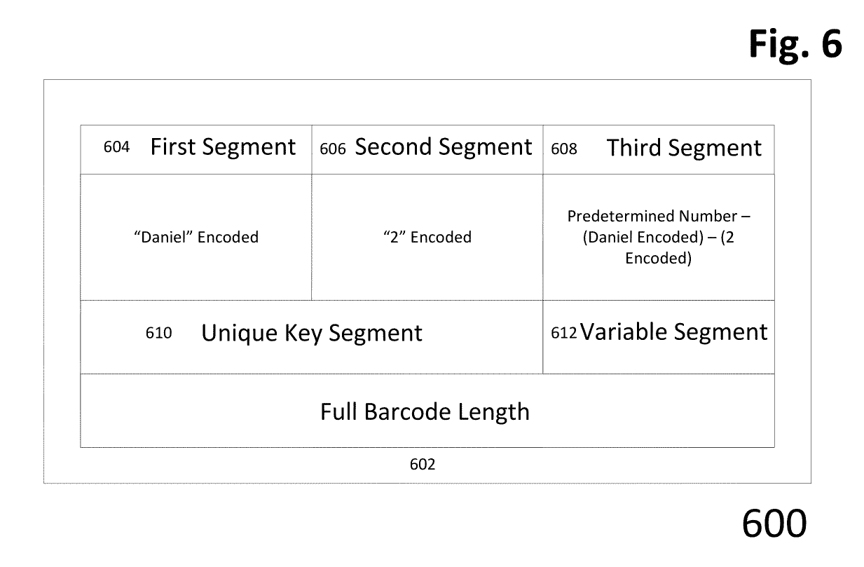

FIG. 6 illustrates an unique consumer identification barcode 600 that is used in conjunction with a non-visual encoded commercial request device according to an example embodiment. Each consumer operating a consumer device 104 is assigned a unique consumer identification barcode 600 by a third party. In an embodiment, the third party is a system administrator and the assignment of the barcode 600 occurs during a consumer registration process. For authentication purposes, a unique consumer identification barcode 600 is a barcode 602 having a full barcode length. The barcode 602 comprises at least three segments: a first segment 604, a second segment 606, and a third segment 608. The combination of the first segment 604 and the second segment 606 is a unique key segment 610 of the barcode 602. The third segment 608 is a variable segment 612 of the barcode 602.

In an embodiment, the first segment 604 is a barcode rendition of the consumer's first name in ASCII. In an embodiment, the first segment 604 is a barcode rendition of the consumer's last name in ASCII. In an embodiment, the first segment 604 is a barcode rendition of the consumer's first and last names in ASCII. For example, the first segment can be a barcode rendition of the first name “Daniel”, or of the first/last name “Daniel Starr” in ASCII. The second segment 606 is selected is a barcode rendition of a number to avoid duplicative entries. For example, if a system administrator is assigning a consumer with the first name of Daniel a unique consumer identification barcode, but an existing consumer with the first name Daniel exists in the system, the number assigned for the second segment will be 2. Accordingly, a barcode rendition of Daniel 2 in ASCII would be supplied as the unique key segment 610 for barcode 602. In an embodiment, the third segment 608 is a barcode rendition of a variable number 612 in ASCII. Variable number 612 is determined by taking a predetermined number, set by the system administrator, and subtracting the ASCII encoded unique key segment 610. The variable number 612 and/or the unique key segment can be used to authenticate the consumer barcode id. In an embodiment, a character encoding scheme, other than ASCII, is used during the barcode rendering.

In an embodiment, the first segment 604, which is a barcode rendition of the consumer's first name in ASCII is used by the consumer device (i.e., one of 104, 106, 108, and 110) such that the associated speaker addresses the consumer with the consumer's name. The consumer's name is used by the consumer device as part of a salutation or as part of a prompt for additional data. The first segment 604 would be decoded by the consumer end device, specifically by the processing device of the consumer end device. For example, in FIG. 2, the processing device 210 of consumer end device 104 applies a text to speech feature that decodes the first segment 604 so that it is stated in audio by the speaker 220 to the consumer as part of a salutation, a prompt, or a message.

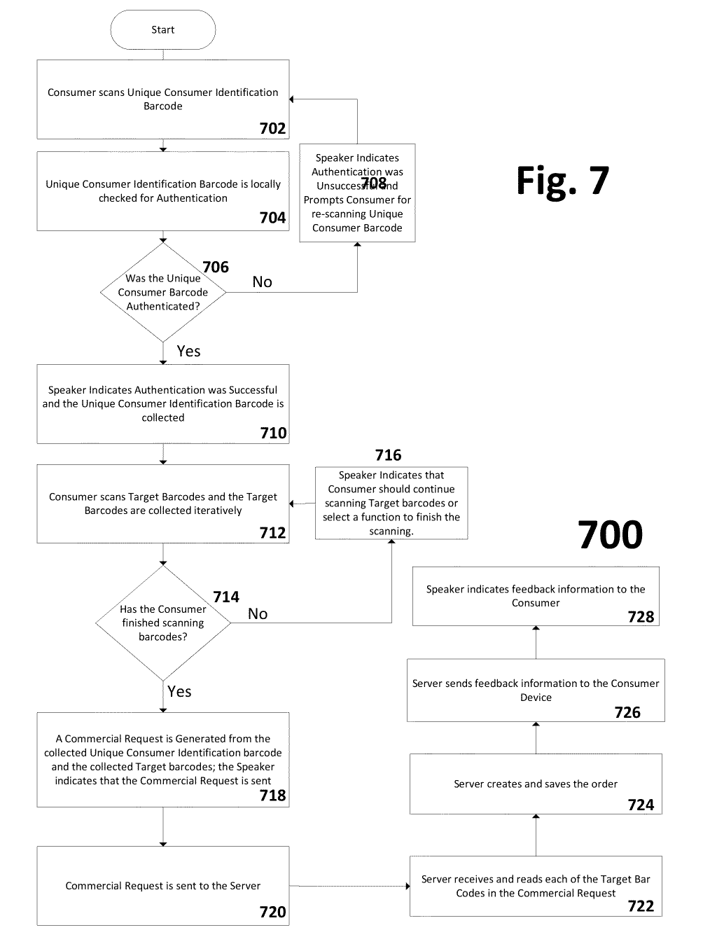

FIG. 7 is a flowchart of a method 700 for generating a commercial request using a non-visual encoded commercial request device according to an example embodiment. The method 700 generates a commercial request initiated by a consumer.

In a first step 702, the consumer scans his assigned unique consumer identification barcode. In an embodiment, the consumer has a barcode booklet such as booklet 500 and a unique consumer identification barcode 502. The consumer scans his unique consumer identification barcode 502 with a barcode scanning device 202. In an embodiment, a consumer uses a mobile device, such as a cellular telephone as his scanning device 202.

In a second step 704, the unique consumer identification barcode is authenticated. The unique consumer identification barcode 502 is transmitted over communication line 204, received at the local communications interface of consumer unit 104, and relayed via communication line 208 to processing device 210. The processing device 210 performs the authentication according to the methods previously described herein. In an embodiment, processing device 210 performs local authentication. In an embodiment, a processor of server 130 performs authentication. In another embodiment, authentication is performed both locally by processing device 210 and by the processor of server 130. To authenticate the unique consumer identification barcode it is checked whether the summation of the unique key segment 610 and variable number segment 612 of the consumer's unique consumer identification barcode is a predetermined number set by a system administrator. In an embodiment, another mathematical functional relationship, other than addition, (that can be implemented in conjunction with addition) is used to authenticate the unique consumer identification barcode.

In a third step 706, it is determined whether authentication of the unique consumer identification barcode was successful. In an example embodiment, if the sum of the unique key segment 610 and variable number segment 612 of the consumer's unique consumer identification barcode is equal to the predetermined number, the local authentication is determined to be successful. If the sum is not equal to the predetermined number, the local authentication is determined to be unsuccessful. In an embodiment, in the event of an unsuccessful authentication, speaker 220 indicates to the consumer that the authentication was unsuccessful, as is shown in step 708. In an embodiment where authentication was unsuccessful, the speaker prompts the consumer to rescan his unique consumer identification barcode. In an embodiment where authentication was unsuccessful, the speaker 220 prompts the consumer to contact the system administrator. In the event of a successful authentication, according to step 710, the speaker indicates to the consumer that the authentication was successful. According to an embodiment where authentication was successful and the unique consumer identification barcode is collected, the speaker prompts the consumer to begin scanning barcodes to formulate a communication request.

In a fourth step 712, the consumer scans a set of target barcodes taken from a global universe of barcodes. In an embodiment, the set of target barcodes includes any barcode in the consumer's barcode booklet 500 such as goods barcodes 508 or services barcodes 510. As the consumer scans each barcode, the target barcode is received by local processing device 210. The received target barcodes and the unique consumer identification barcode are collected by processing device 210.

In fifth step 714, it is determined whether the consumer has finished scanning barcodes. In an embodiment, the processing device determines that a consumer has finished scanning barcodes when the consumer initiates a “save” by scanning an appropriate barcode, such as “SAVE/YES” barcode 504 from the consumer barcode booklet 500. In an embodiment, the processing device determines that a consumer has finished scanning barcodes when a predetermined period of time has passed since the most recent consumer scan. If the processing device determines that the consumer has not finished scanning, in an embodiment the processing device prompts the speaker to request that the consumer continue scanning target barcodes or that the consumer scan a specific barcode, such as “SAVE/YES” barcode 504, to finish the scanning. If processing device 210 determines that the consumer has finished scanning, in an embodiment shown in step 718 the processing device directs the speaker to indicate to the consumer that the target barcodes are being sent to the server as a commercial request. The processing device can be programmed to recognize various consumer scanning actions as a save function. Responsive to the consumer not indicating that he has finished scanning, according to step 716, the speaker indicates to the consumer that the consumer should continue scanning target barcodes or select a function to finish the scanning.

In a sixth step 720, the commercial request is sent to the server. In an embodiment, the commercial request is sent over a communication line such as communication line 120.

In seventh step 722, the server receives the commercial request that includes the unique consumer identification barcode and the target barcodes, and the processing device of the server 130 reads each of the barcodes. The server's processing device reads each barcode in the commercial request, and for each target barcode the processing device of the server searches the database 134 to determine its associated item. In an embodiment, the processing device of the server evaluates the target barcodes by reading each target barcode. The processing device of the server then processes the target barcodes by associating each barcode with an Article ID. In an embodiment, the server processes the unique consumer barcode by associating it with stored consumer information. In an embodiment, the server, for each article ID or barcode, determines which one of the vendors from the total set of m vendors has that particular good (or service) in stock (or available). In an embodiment, the processor of the server records the time of receipt of the commercial request and processes the order by creating an order number and assigning the commercial request to an order number. In an embodiment, the server performs further authentication of the unique consumer barcode that is in addition to the authentication performed at the non-visual encoded commercial request device.

In an eighth step 724, the server saves the processed commercial request as an order record. The server saves the commercial request as an order record by sending the request to the database via communication line 132 and saving it as an order in the database order records 408.

In a ninth step 726, the processing device of the server sends feedback to the non-visual encoded commercial request device. In an embodiment, the server retrieves the order from the database order records 408 and selects a field to be communicated back to the consumers. The selected field can be a total price, such as total price 446, or in an embodiment it can be the fulfilling vendor name. Once the field is retrieved from database 134 over communication line 132, the server 130 sends the feedback, as translated in part by a text to speech application, over communication line 120 to a non-visual encoded consumer request device. The feedback is received at the global communication interface 214 and it is sent over communication line 212 to processing device 210. Processing device 210 then forwards the feedback over communication line 208 to local communication interface 206. Local communications interface then forwards the feedback to speaker 220 so that it the feedback is reproduced as audio feedback for the consumer.

In a tenth step 728, the speaker indicates feedback regarding the communication request. In an embodiment, the feedback communicates that the communication request has successfully been stored in the server and database environment 128. In an embodiment, the speaker indicates feedback regarding the stored communication request after a vendor has provided or altered fulfillment information. In an embodiment, the audio feedback is replayed, or stored locally, until an acknowledgment of the feedback is made by the consumer.

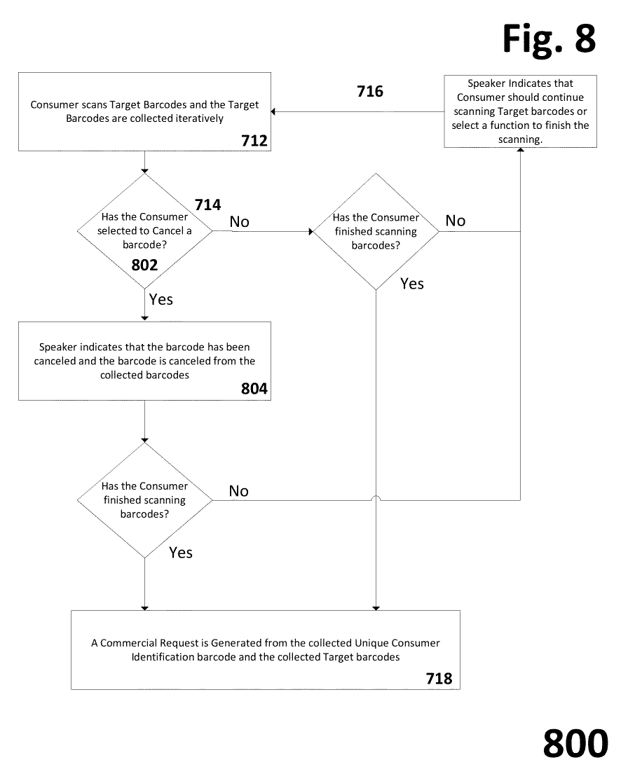

FIG. 8 is a flowchart of a method 800 for generating a commercial request using a non-visual encoded commercial request device according to an example embodiment. The method 800 allows for a consumer to cancel one of his previously scanned barcodes to alter the commercial request. At step 802, it is determined whether a consumer has selected to cancel a recently scanned barcode. Responsive to the consumer not having canceled a barcode, the generation of the commercial request is still in progress and the consumer can scan additional target barcodes in accordance with step 716. Responsive to the consumer canceling a barcode, and in accordance with step 804, a recently scanned barcode is canceled and the speaker 220 announces to the consumer that a recently scanned barcode has been canceled. By canceling a barcode, the barcode is removed from the collection of target barcodes. In an embodiment, a consumer can cancel all scanned barcodes and start over by scanning new or a different variety of target barcodes. In an embodiment, the consumer can cancel the commercial request. In an embodiment, the customer can not cancel the commercial request. In an embodiment, the consumer cancels only the most recent scanned target barcode. As shown in FIG. 5, a consumer selects to cancel a barcode by scanning a “cancel” barcode 506 that is included in the consumer's barcode booklet.

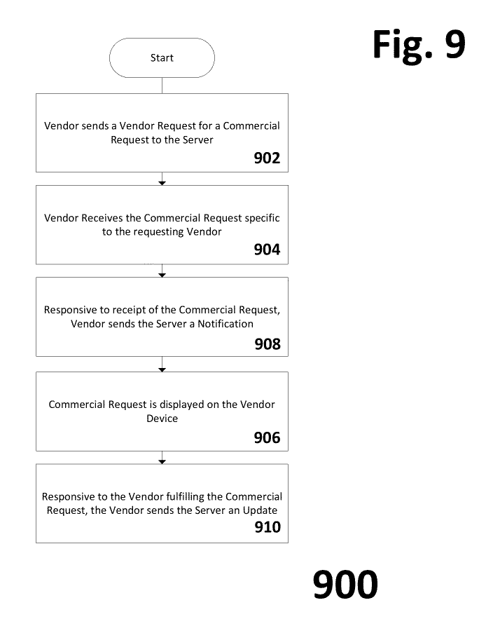

FIG. 9 is a flowchart of a method for accessing and altering a processed commercial request by a vendor according to an example embodiment. The method 900 generates a vendor request initiated by a vendor to access a vendor specific stored commercial request.

In a first step 902, the vendor sends from its vendor device a vendor request to the server in order to access commercial requests. In an example embodiment, the vendor 150 sends from vendor device 144 a vendor request over communication line 136 to server 130.

In a second step 904, the vendor receives from the server the commercial request. In an example embodiment, server 130 identifies all pending stored commercial requests in database 134 and determines which of those requests are associated with the vendor sending the vendor request. As an example, vendor 150 would not receive the commercial requests pending that involve vendor 152. Server 130 sends the commercial request over communication line 136 to vendor device 144.

In a third step 908, the vendor device displays the received commercial request. In an example embodiment, vendor 150 would access vendor device 144 and view the commercial request over a vendor interface. In an example embodiment, the vendor interface resembles the vendor interface of FIG. 3.

In an embodiment, the vendor can send over the server a notification to the consumer after having received the commercial request. The vendor wants the consumer to know that their order has been received by the vendor and that it is in the process of being filled. The vendor notification step is shown in step 906. In an embodiment, the notification of receipt is automatically sent to the server.

In step 910, the vendor sends an update to the server upon filling the commercial request. Vendor 150, after having filled the commercial request, updates the commercial record by sending updated information to change the fulfillment information associated with the commercial request stored in database 134. In an embodiment, the information regarding fulfillment is automatically updated when the vendor notes that the commercial request has been filled.

In the aforementioned embodiments, a speaker is described as indicating various messages to the consumer. In these instances, the processing device 210 of the non-visual encoded commercial request device provides a specific message to the speaker that it has translated from text to speech by applying the text to an application programming interface (API). In an embodiment, the processing device of the server translates a specific message, such as feedback, from text to speech by applying the text to an API.

It should be appreciated that the present invention can be implemented in numerous ways, including as a process, an apparatus, a system, a computer processor executing software instructions, a mobile device, a smart device, a mobile application, or a computer readable medium such as a non-transitory computer readable storage medium, or a computer network wherein program instructions are sent over optical or electronic communication or non-transitory links. It should be noted that the order of the steps of disclosed processes can be altered within the scope of the invention, as noted in the appended claims and in the description herein.

Although the foregoing invention has been described in some detail for purposes of clarity of understanding, it will be apparent that certain changes and modifications can be practiced within the scope of the appended claims. The present invention can be practiced according to the claims and/or the embodiments without some or all of these specific details. Portions of the embodiments described herein can be used with or without each other and can be practiced in conjunction with a subset of all of the described embodiments. For the purpose of clarity, technical material that is known in the technical fields related to the invention has not been described in detail so that the present invention is not unnecessarily obscured. It should be noted that there are many alternative ways of implementing both the process and apparatus of the present invention. Accordingly, the present embodiments are to be considered as illustrative and not restrictive, and the invention is not to be limited to the details given herein, but can be modified within the scope and equivalents of the appended claims.

What is claimed is:

1. A method for generating a commercial request using a non-visual encoded commercial request system, the method comprising:
scanning, by a barcode scanning device, a consumer identification barcode;
authenticating, by a processing device, the consumer identification barcode;
collecting, by the processing device, the consumer identification barcode;
responsive to the consumer identification barcode being successfully authenticated, scanning, by the barcode scanning device, a set of target barcodes;
collecting, by the processing device, the set of target barcodes;
generating, by the processing device, a commercial request including the collected consumer identification barcode and the collected set of target barcodes;
sending, by the processing device, the commercial request to a server; and
responsive to the server successfully receiving the commercial request, sending, by the processing device, a message to a speaker associated with the non-visual commercial request system.

2. The method as recited in claim 1, further comprising:
responsive to the consumer identification barcode being successfully authenticated, indicating, by the speaker, that the authentication was successful; and
responsive to the consumer identification barcode being unsuccessfully authenticated, indicating, by the speaker, that the authentication was unsuccessful,
wherein the authenticating of the consumer identification barcode is performed by comparing a summation of a unique key segment of the consumer identification barcode and a variable segment of the consumer identification barcode to a predetermined number.

3. The method as recited in claim 1, wherein the barcodes included in the set of target barcodes are a type that is one of a goods type or a services type.

4. The method as recited in claim 1, further comprising:
scanning, by the barcode scanning device, a barcode to indicate that a consumer is finished scanning barcodes; and
responsive to the barcode being scanned, generating by the processing device the commercial request.

5. The method as recited in claim 1, further comprising:
scanning, by the barcode scanning device, a barcode to indicate that a consumer is canceling an at least one previously scanned barcode.

6. The method as recited in claim 5, wherein the at least one previously scanned barcode is a target barcode that is one of a most recently scanned target barcode or all scanned target barcodes.

7. The method as recited in claim 1, wherein the consumer identification barcode comprises a unique key segment and a variable segment.

8. A non-visual encoded commercial request device for generating a commercial request, the device comprising:
a barcode scanner,
a speaker,
a communications interface having at least a receiving element and a transmitting element, and
a processing device,
wherein the receiving element of the communications interface receives a consumer identification barcode and a target set of barcodes from the barcode scanner,
wherein the processing device collects the consumer identification barcode, authenticates the consumer identification barcode, collects the target set of barcodes, generates a commercial request from the collected consumer identification barcode and the collected set of target barcodes, and sends the commercial request over the transmitting element of the communications interface to a server, and
wherein, responsive to receipt at the transmitting element of a confirmation signal from the server, the processing device transmits over the transmitting element a confirmation of receipt of the commercial request to the speaker.

9. The non-visual encoded commercial request device as recited in claim 8, wherein connections between the barcode scanner, the speaker, the communications interface, and the processing device are formed using one of: wireless connections or wired connections.

10. A vendor environment system for retrieving a commercial request from a server, the system comprising:
sending, by a processing device of a vendor device, a vendor request initiated by a vendor for the commercial request to a server;
receiving, by the processing device of the vendor device, all commercial requests specific to the vendor that are identified by the server in response to the vendor request; and
displaying, by a display of the vendor device, all received commercial requests.

11. The vendor environment system as recited in claim 10, the system further comprising:
responsive to receipt of the commercial request, sending, by the processing device of the vendor device, to the server a notification from the vendor to be associated with the commercial request.

12. The vendor environment system as recited in claim 10, the system further comprising:
responsive to the vendor fulfilling the commercial request, sending, by the processing device of the vendor device, to the server an update to modify fulfillment data associated with the commercial request.

13. A server environment system for saving a commercial request, the system comprising:
receiving, by a processing device of a server, a commercial request generated by a non-visual encoded commercial request device;
evaluating, by the processing device of the server, each barcode in the commercial request;
processing, by the processing device of the server, each evaluated barcode in the commercial request to associate each evaluated barcode with identifying information;
saving, by the processing device of the server, the processed commercial request as an order, and
sending, by the processing device of the server, a message to the non-visual encoded commercial request device that the order has been saved,
wherein the commercial request has a plurality of barcodes including a consumer identification barcode and at least one target barcode.

14. A server environment system as recited in claim 13, the system further comprising:
authenticating, by the processing device of the server, the consumer identification barcode by comparing a summation of a unique key segment of the consumer identification barcode and a variable segment of the consumer identification barcode to a predetermined number.

15. A server environment system as recited in claim 13, the system further comprising assigning, by the processing device of the server, the saved order to a vendor for fulfillment.

16. A server environment system as recited in claim 13, wherein the server environment system includes a database storing at least one of: (i) consumer information, (ii) barcode supply information, and (iii) saved orders.

17. A server environment system as recited in claim 13, the system further comprising:
recording, by a processing device of the server, a time at which the commercial request was received;
assigning, by a processing device of the server, an order number to the commercial request and the recorded time to the commercial request; and
sending, by a processing device of the server, feedback to the non-visual encoded commercial request device describing the status of the commercial request.

18. A server environment system as recited in claim 15, the system further comprising:
responsive to a vendor sending the server a vendor request for access to pending orders for the vendor, the processing device of the server:
determining if any orders are assigned to the vendor,
retrieving assigned orders from the saved orders, and
transmitting the assigned orders to the vendor.

19. A server environment as recited in claim 15, wherein the saved order is assigned to the vendor by optimizing a fulfillment factor across all available vendors.

20. A non-transitory computer-readable storage device storing program instructions that, when executed, cause a processing device to perform a method for generating a commercial request using a non-visual encoded commercial request system, the method comprising:
authenticating, by the processing device, a consumer identification barcode;
collecting, by the processing device, the consumer identification barcode;
collecting, by the processing device, a set of target barcodes;
generating, by the processing device, a commercial request from the collected consumer identification barcode and the collected set of target barcodes;
sending, by the processing device, the commercial request to a server; and
responsive to the server successfully receiving the commercial request, sending, by the processing device, a message to a speaker associated with the non-visual commercial request system.
